(19) United States
(12) Patent Application Publication
(10) Pub. No.: US 2013/0124578 A1
(43) Pub. Date: May 16, 2013

(54) COLUMN-ORIENTED DATABASE SCHEMA FOR DYNAMIC HIERARCHIES

(71) Applicants: Mahender R. Vangati, San Jose, CA (US); Janakiraman Gopalan, Cupertino, CA (US)

(72) Inventors: Mahender R. Vangati, San Jose, CA (US); Janakiraman Gopalan, Cupertino, CA (US)

(73) Assignee: MOTOROLA SOLUTIONS, INC., SCHAUMBURG, IL (US)

(21) Appl. No.: 13/298,061

(22) Filed: Nov. 16, 2011

(51) Int. Cl. G06F 17/30

(52) U.S. Cl. 707/803; 707/E17.005

(57) ABSTRACT

A method and system for a column-oriented database schema for dynamic hierarchies includes a processor (200) establishing (300) a column-oriented database in a memory (202) of a network manager and configuring (304) the database with row keys, wherein each row key is concatenated with a leaf node identifier listed first, followed by the root node identifier and identifiers of intervening parent node traversing to the leaf node from the root node.

### FIELD OF THE DISCLOSURE

The present invention relates generally to system databases, and more particularly to a schema to implement searching a database, such as for a wireless communication systems.

### BACKGROUND

With the adoption of wireless telecommunication devices such as smartphones and tablets, ubiquitous roaming is becoming a requirement for most businesses and corporations. This requirement in turn is driving the adoption of new wireless technologies, which must be accommodated by a system network administrator. In particular, a network administrator must deploy, maintain, manage, monitor, and troubleshoot these wireless communication networks.

In addition, these networks are becoming more complicated and must handle ever increasing amounts of information, which is driving up the requirements on the network management solutions to be able to provide a centralized management solution to address vast amounts of network data related to traffic, security, firewalls, local area networks, new devices, etc.

In particular, and related to the increasing amounts of data, it has become necessary to provide mechanisms to be able to retrieve network data at very fast speeds. One solution is provides a schema for a database having a persistent map of keys to values. The schema involves column keys that are grouped into sets called column families which form the basic unit of access control where all data stored in a column family is usually of the same type. Data is maintained in lexicographic order by row key. However, this solution does not address storing dynamic hierarchy changes and the different ways row keys should be generated to store these dynamic hierarchy changes.

Accordingly, there is a need for a new technique to store dynamic hierarchy changes in a structural database and retrieve data associated with these changes in an efficient manner. In particular, there is a need to track the network hierarchy changes with client device (e.g. smartphone, tablet, laptop) associations over time.

### BRIEF DESCRIPTION OF THE FIGURES

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 is a simplified block diagram of a system, in accordance with the present invention.

FIG. 2 is a simplified block diagram of a device, in accordance with the present invention.

FIG. 3 is a flowchart of a method, in accordance with the present invention.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

A system and method is described for a new technique that stores dynamic hierarchy changes in a structural database and retrieves data associated with these changes in an efficient manner. In particular, the present invention can track the network hierarchy changes with client device (e.g. smartphone, tablet, laptop) associations over time. In particular, the present invention provides a schema for persisting dynamically changing hierarchy in column-oriented databases.

As applied to wireless communication networks, almost all of the wireless network management solutions today in the field use a standard Structured Query Language (SQL) database. Practically none of these solutions have explored the usage of a No-SQL or column-oriented data structures. The present invention describes how these new data stores can be leveraged for wireless network management solutions. In particular, the present invention would be used to persist all the wireless network data and present the data in a very useful manner for network administrators. Specifically, the present invention could be used for the Network Operations Center Management solution for wireless local area communication network, and could be leveraged in cloud deployments.

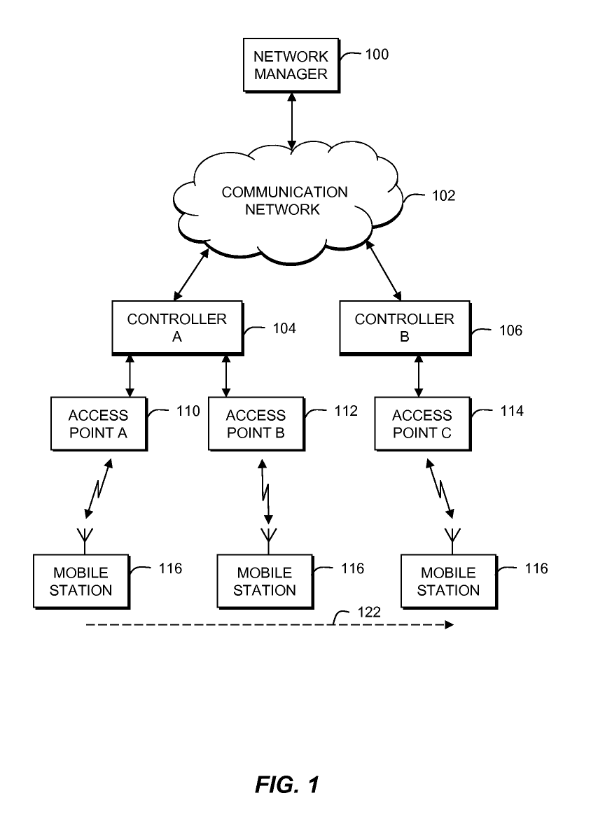

FIG. 1 is a block diagram depiction of a wireless communication network manager 100 that utilizes a column-oriented database schema for dynamic hierarchies, in accordance with the present invention. The network manager is operable to control the operations of a wired and/or wireless communication network 102 that can include controllers 104, 106, access points 110, 112, 114, and one or mobile station 116 that is able to roam 112 in the network among different access pints and associate controllers. Of course it should be recognized that many other devices and entities can exist and be managed in the network, which are not shown for the sake of brevity. Accordingly, the devices shown in FIG. 1 are for the examples represented herein, but it should be recognized that the present invention is also applicable to any other system using a column-oriented database. The network manager 110 in the example shown is operable in accordance with the present invention and as will be detailed below.

The wireless communication network manager is operable on either or both of local and wide-area networks, or other IEEE 802.11 wireless communication systems. However, it should be recognized that the present invention can also be applied to other wired or wireless communication systems. For example, the description that follows can apply to one or more communication networks that are IEEE 802.xx-based, employing wireless technologies such as IEEE's 802.11, 802.16, or 802.20, or Internet-based, modified to implement embodiments of the present invention. The protocols and messaging needed to establish such networks are known in the art and will not be presented here for the sake of brevity.

Various entities are adapted to support the inventive concepts of the embodiments of the present invention. Those skilled in the art will recognize that FIG. 1 does not depict all of the equipment necessary for system to operate but only those system components and logical entities particularly relevant to the description of embodiments herein. For example, routers, controllers, switches, access points/ports, and wireless clients can all include separate communication interfaces, transceivers, memories, etc. all under control of a central processor. In general, components such as processors, transceivers, memories, and interfaces are well-known. For example, processing units are known to comprise basic components such as, but not limited to, microprocessors, microcontrollers, memory cache, application-specific integrated circuits, and/or logic circuitry. Such components are typically adapted to implement algorithms and/or protocols that have been expressed using high-level design languages or descriptions, expressed using computer instructions, expressed using messaging logic flow diagrams.

Thus, given an algorithm, a logic flow, a messaging/signaling flow, and/or a protocol specification, those skilled in the art are aware of the many design and development techniques available to implement a processor that performs the given logic. Therefore, the entities shown represent a known system that has been adapted and modified, in accordance with the description herein, to implement various embodiments of the present invention. Furthermore, those skilled in the art will recognize that aspects of the present invention may be implemented in and across various physical components and none are necessarily limited to single platform implementations. For example, the memory and control aspects of the present invention may be implemented in any of the devices listed above or distributed across such components. In particular, the security module and data rate limiter could be embodied with the processor.

Referring back to FIG. 1, the present invention describes a schema for column-oriented databases which allows a processor of the network manager to be able to track the leaf node associations to its parent nodes over a period of time, maintain any data history across these movements, and provide the ability to perform fast seek access when retrieving this information into memory. This process also allows the users to go back at a previous time and look, at that previous time, how their child nodes were associated, and retrieve the associated data in an efficient manner.

A parent node can have any number of child nodes associated to it. Each node has an identifier (ID), that need not be unique, to identify it. However, a leaf node has a unique identifier (UUID). At any given time, a parent node can contain any number child nodes or any number of leaf nodes. A leaf node can be under only one parent node at any point in time, but can have different parent nodes over a period of time. In the example shown, the mobile station 116 can be a leaf (child) node, and an associated controller and access points can be parent nodes. Further, and access point can also be a child node of a controller parent node. In this example, the network manager 100 can be the root node.

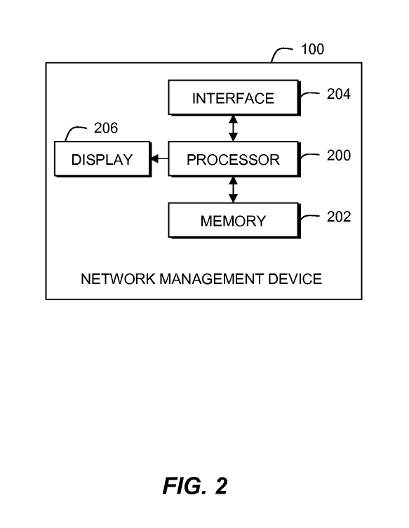

Referring to FIG. 2, the network management device can include a processor 200 coupled to an interface 204 for communicating with the communication network, and a memory 202 that can include a local or remote hard-drive, a distributed (cloud) arrangement, or any other type of storage means. The processor is operable to store and manage a database of communication network nodes under its control. In particular, a column-oriented database is stored and manipulated as will be described below.

A typical column-oriented database has concepts like row key, column family, column qualifier, and cell values. For the purposes of the present invention, it is only necessary to focus on a row key. The database concepts of column family, column qualifier, and cell values are known in the art and will not be discussed here. Row key defines how a column-oriented database can store the information on a hard-drive or other memory device and hence is a key factor for fast retrieval of this information.

A typical row key for a leaf node can be created by using the parent node identifiers in the hierarchy from the root node. For example,
RootNodeID.ParentNodeID . . . ParentNodeID.LeafNodeID
   where the row key is just a concatenation of all the node identifiers in the tree path traversing to the leaf node of interest. When the leaf node is not changing its parent node associations, the above format for the row key might suffice for database searches.

However, if the leaf node keeps changing its association with parent node, and the processor requires that all the information of a leaf node be stored sequentially on the hard-drive, then this row key arrangement is insufficient for fast information retrieval. Therefore, for faster retrieval in accordance with the present invention, the proposed row key would have the leaf node identification in reverse order, such as:
LeafNodeID.RootNodeID.ParentNodeID . . . ParentNodeID

This arrangement of the row key, where the leaf node is listed first in the row key with the remaining hierarchy order intact, ensures that as the leaf node is changing its association to its parent node, the row keys that are being generated are also changing but are, alphabetically, next to each other. Based on this row key, the column-oriented database would store the entire node's history in a sequential order. This allows for much faster data seek time and fewer disks reads, irrespective of the migration pattern of that leaf node.

For example, consider that a leaf node moved between three different parent nodes over a period of time. The generated row keys would be as follows:

LeafNode1.RootNodeID.ParentNodeID . . . ParentNode1
LeafNode1.RootNodeID.ParentNodeID . . . ParentNode2
LeafNode1.RootNodeID.ParentNodeID . . . ParentNode3

where the data associated with each row key would be stored sequentially on the hard-disk because the row keys are sequential. This also implies that all the data for LeafNode1 is stored on a single “region” when considering the scenarios where the data is spread across server farms or multiple “regions”. This decreases the number of reads to the database thereby decreasing the leaf node data seek time.

A typical embodiment for the above schema would be for wired and wireless local area network management systems, where a typical schema would contain parent nodes that could represent geographical hierarchy, association hierarchy, custom grouping hierarchy or other similar arrangements; and leaf nodes that typically represent mobile stations, access points, and wired or wireless controllers. From most management systems, it is very important to persist this hierarchy with the database and represent them to the user. This helps the users in understanding their network deployment layouts. The problem with previous systems is that the persisted hierarchy and leaf node associations are static and represent the current snapshot. Also, previous management systems use the top down key approach. So a user would not be able to identify which, at a specific time, which leaf node was associated to which parent node. In contrast, the present invention allows storing mobile stations, access points, and controller associations to different parent nodes. The present invention would also allow the retrieval of data associated to the nodes in short period of time.

In the embodiment above, device types are not distinguished. However, applications might have different types of devices. In such cases, it is advantageous to store specific types of devices in a contiguous location on the hard-drive. This can be achieved by prepending a distinguishing string for a specific device to the devices' row key itself. For example, all mobile stations could be stored with row key as
m.DeviceRowKey
   and all access points as

ap.DeviceRowKey

which allows the database processor to store data of similar device types sequentially which can help drastically in seek time.

The database schema of the present invention can also be extended to support multi-tenancy. This can be achieved by prepending a customer ID before any row key. For example:
customerID.LeafNodeID.ParentNodeID . . . ParentNodeID.RootNodeID
   where the database can persist customer specific information at one contiguous place, within a region. This becomes especially relevant in server farms and cloud based deployments as the overall customer specific data seek time is reduced.

Once the database is established and stored in the memory 202, the processor 200 of the network management device 100 can search the database in the memory 202 for a particular leaf node identifier for values that are mapped to the row key and display the search results on a display 206 of the device (e.g. user terminal).

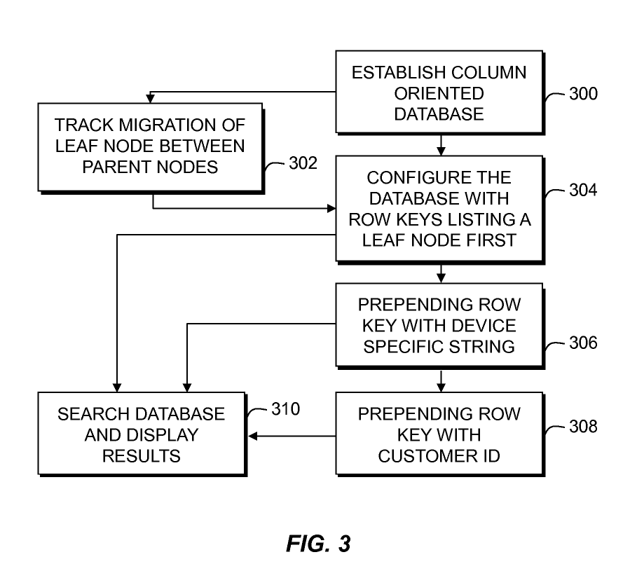

FIG. 3 illustrates a flowchart of a method for a column-oriented database schema for dynamic hierarchies, in accordance with the present invention. The method includes a step 300 of establishing a column-oriented database in a memory of a network manager.

A next step 302 includes tracking a migration of leaf node between parent nodes.

A next step 304 includes configuring the database with row keys, wherein each row key is concatenated with a leaf node identifier listed first, followed by the root node identifier and identifiers of intervening parent node traversing to the leaf node from the root node. Where a leaf node is tracked (from 302), configuring includes storing a history of the leaf node migration in a sequential order of row keys in the database. The method can then proceed to step 310.

An optional next step 306 includes prepending the row key with a string that is device specific. The method can then proceed to step 310.

Another optional next step 308 includes prepending the row key with a customer identifier. The method can then proceed to step 310.

A next step 310 includes searching the database for a particular leaf node identifier for values that are mapped to the row key and displaying the search results on a user terminal.

Advantageously, the system and method described herein can utilize column-oriented databases with; extremely flexible schemas, very easy migration paths between different builds with different data persistence schema, extremely quick access to data, ability to change schema dynamically, and very easy access to historical data at any point in time.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

It will be appreciated that some embodiments may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

What is claimed is:

1. A manager that utilizes a column-oriented database schema for dynamic hierarchies, the network manager comprising:
a memory operable to store the database; and
a processor coupled to the memory, the processor operable to configure the database with row keys, wherein each row key is concatenated with a leaf node identifier listed first, followed by the root node identifier and identifiers of intervening parent node traversing to the leaf node from the root node.

2. The manager of claim 1, wherein the manager is a local area communication network manager, and the leaf node identifies one of the group of a mobile station and an access point.

3. The manager of claim 1, wherein the processor is further operable to track a migration of leaf node between parent nodes, and store a history of the leaf node migration in a sequential order of row keys in the database.

4. The manager of claim 2, wherein the parent nodes represent one of the group of a geographical hierarchy and association hierarchy of the communication network.

5. The manager of claim 4, wherein the hierarchy persists with the database.

6. The manager of claim 1, wherein the row key is prepended with a string that is device specific.

7. The manager of claim 1, wherein the row key is prepended with a customer identifier.

8. The manager of claim 1, wherein the processor is further operable to search the database for a particular leaf node identifier for values that are mapped to the row key, and then display the search results on a user terminal.

9. A system that utilizes a column-oriented database schema for dynamic hierarchies, the system including a network manager comprising:
a memory operable to store the database; and
a processor coupled to the memory, the processor operable to configure the database with row keys, wherein each row key is concatenated with a leaf node identifier listed first, followed by the root node identifier and identifiers of intervening parent node traversing to the leaf node from the root node.

10. A method for a column-oriented database schema for dynamic hierarchies, the method comprising the steps of:
establishing a column-oriented database in a memory of a network manager; and
configure the database with row keys, wherein each row key is concatenated with a leaf node identifier listed first, followed by the root node identifier and identifiers of intervening parent node traversing to the leaf node from the root node.

11. The method of claim 10, further comprising tracking a migration of leaf node between parent nodes, and configuring includes storing a history of the leaf node migration in a sequential order of row keys in the database.

12. The method of claim 10, further comprising prepending the row key with a string that is device specific.

13. The method of claim 10, further comprising prepending the row key with a customer identifier.

14. The manager of claim 10, further comprising searching the database for a particular leaf node identifier for values that are mapped to the row key, and displaying the search results on a user terminal.
